(19) United States
(12) Patent Application Publication
(10) Pub. No.: US 2014/0089195 A1
(43) Pub. Date: Mar. 27, 2014

(54) PERSON TO PERSON PHOTO PAYMENTS

(71) Applicants: Laura Ward, San Jose, CA (US); Egan Schulz, San Jose, CA (US)

(72) Inventors: Laura Ward, San Jose, CA (US); Egan Schulz, San Jose, CA (US)

(21) Appl. No.: 14/032,089

(22) Filed: Sep. 19, 2013

Related U.S. Application Data
(60) Provisional application No. 61/705,567, filed on Sep. 25, 2012.

(51) Int. Cl. G06Q 20/22

(52) U.S. Cl. CPC G06Q 20/223
USPC 705/44; 705/39

(57) ABSTRACT

Photos of recent or prior payees are shown on a user device, such as a smart phone or tablet. The user or payer can select a photo, enter an amount to send, and confirm a payment. The payment provider then processes the payment with minimal input from the payer. Because the photos are of recent or previous payees, the user is able to make a person to person payment with less steps than conventional person to person payments.

### CROSS REFERENCE TO RELATED APPLICATION

Pursuant to 35 U.S.C. §119(e), this application claims priority to U.S. Prov. App. Ser. No. 61/705,567, filed Sep. 25, 2012, which is incorporated by reference in its entirety.

### BACKGROUND

1. Technical Field

The present application generally relates to electronic payments and more particularly to person to person payments.

2. Related Art

Conventional person to person (P2P) payments include a sender writing a check or providing cash and delivering the check or cash to a recipient, such as in person or through the mail. More recently, payment providers, such as banks and PayPal®, Inc. of San Jose, Calif., offer services that allow the sender to pay the recipient electronically with electronic funds. Typically, the sender logs into the sender's account with the payment provider, selects an option to send a payment, enters in a sender's information, such as an email address or phone number, enters an amount to send, selects a funding source, optionally enters a message, and confirms the payment.

However, such a process can be time consuming and inconvenient for the sender, especially if the sender does not know the required recipient information immediately or if entering such information is difficult, such as due to a small keypad. Information entry may also be difficult due to the user and/or the user device being in motion, such as in a car, walking, etc. Information may also be entered incorrectly, such that funds may be inadvertently sent to an unintended recipient.

Therefore, there is a need for users to be able to send money to others more easily through their mobile devices.

### BRIEF DESCRIPTION OF THE DRAWINGS

FIG. 1 is a flowchart showing a process a payment provider makes in processing a person to person photo payment request according to one embodiment;

FIGS. 2A-2D are exemplary screen shots a user may see for making a person to person photo payment according to one embodiment;

FIGS. 3A-3G are exemplary screen shots a user may see for making a person to person photo payment according to another embodiment;

FIG. 4 is block diagram of a networked system suitable for implementing the process described herein according to an embodiment; and

FIG. 5 is a block diagram of a computer system suitable for implementing one or more components in FIG. 4 according to one embodiment.

### DETAILED DESCRIPTION

In one embodiment, photos of recent or prior payees are shown on a user device, such as a smart phone or tablet. The user or payer can select a photo, enter an amount to send, and confirm payment. The payment provider then processes the payment with minimal input from the payer. Because the photos are of recent or previous payees, the user is able to make a person to person payment with fewer steps than conventional person to person payments.

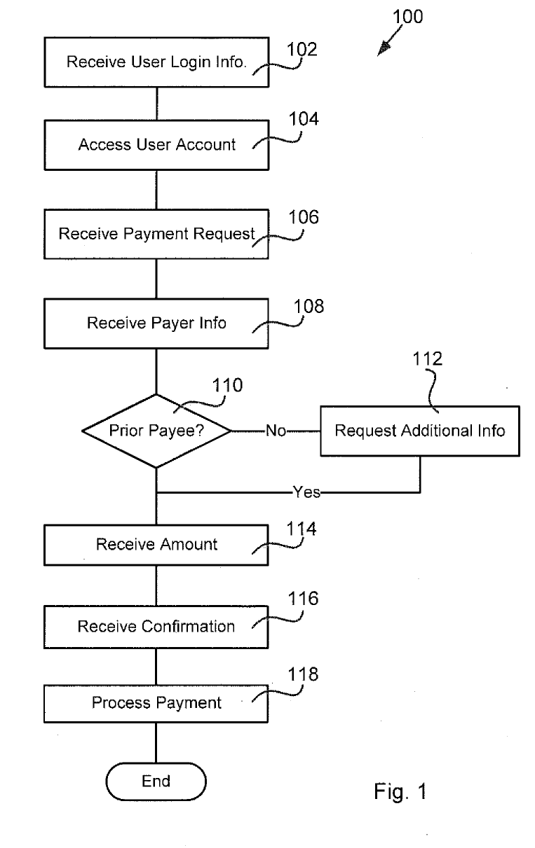

FIG. 1 is a flowchart showing a process 100 a payment provider makes in processing a person to person photo payment request according to one embodiment. At step 102, the payment provider, such as PayPal®, Inc. of San Jose, Calif., receives login information from a user or payer, such as from a user device like a smart phone, computing tablet, PC, wearable (e.g., Google Glass® or smart watch), or other computing device. The user may first access a mobile app or URL of the payment provider and then provide the requested login information, such as a user identifier (e.g., email address, user name, account number, or phone number) and an authenticator (e.g., a password or PIN). If the device is remembered by the payment provider, only the password or PIN may be requested from the user, with the user identifier being prefilled by the payment provider.

Based, at least in part, on the received login information, the payment provider accesses the user's account at step 104, such as by searching an account database using the user identifier and confirming the authenticator (password/PIN) matches the associated account. If the user account cannot be accessed, does not exist, or is inactive, the payment provider may request the user for additional information, to reenter the earlier requested information, or to update information, such as an expired funding source, new mailing address, etc.

After account access, the payment provider may receive a person to person (P2P) payment request from the user at step 106. The P2P request may be received from the app or payment provider online site through a tab, button, or other feature the user selects for requesting the P2P payment. For example, on the account home page or other page, such as a services or transfer page, there may be “Send” or “Pay” tab or button the user can tap or otherwise select for sending money to another person. When the user selects a tab, button, or link, a request to send money is communicated to the payment provider through the user device.

The user may also see a tab, button, or link that indicates a desire for the user to request money to be sent to the user (where the user is now a payee instead of a payer). Such a tab or button may be indicated as “Receive” or “Request Money” on an account page of the user. Selection of the tab or button communicates a receive money request to the payment provider.

In order to process a request to send money or to receive money, the payment provider needs to know the identity of the payee or the payer, respectively. With conventional methods, the user typically has to enter a payee phone number or email address manually. However, with one or more embodiments of the present disclosure, the user may be presented with one or more photos of recent or prior payees, i.e., recipients who have received payments from the user in the past from which to select from in order to convey payee information.

In one embodiment, when the payment provider receives a request to send money, it may determine, from the user's account, names or identifiers of user payees (recent or any prior). Photos of the payees may also be stored with and available to the payment provider. Photos may also be available through the user's device or through publicly available sources, such as social or networking sites. If no photos are available, the payment provider may simply provide the names of prior payees initially to the user through the user device.

In another embodiment, the user may be presented with photos of all people in the user's contact list, all prior payees, or another set or subset of photos. The set or subset may be potential payees from the user's contact list, all prior payees, or recent payees that are within a certain vicinity of the user's current location. To determine this, the payment provider obtains a location of the user, such as through a GPS functionality of the user device. The vicinity may be predetermined by the system, such as one mile, five miles, etc. The distance may be based on rate of movement of the user (or user device), where a higher rate of movement may result in a larger distance. For example, if the rate of movement indicates that the user is likely walking, the distance may be ½ mile, but if the rate of movement indicates the user is driving a car on a highway, the distance may be five miles (or more). Also, the direction of movement may be a factor as well, as potential payees may only be shown along a route or direction of the current movement.

In another embodiment, photos of potential payees are determined with some initial input by the user or payer. For example, the user may be asked to enter a name of a payee (either first or last). As the user enters letters, the user device or the payment provider starts displaying contacts or previous payees that have matching letters, such as through a name list from the user's contact list or other means/sources. The user may select a desired contact or continue entering letters until the desired contact is presented. When the desired payee is selected, a photo may be obtained by the payment provider.

Thus, the payment provider is able to present the user with photos (and names if desired) of previous user payees. Note that, in some embodiments, the payment provider may only present recent payees, e.g., payees within the last year, last 6 months, or other time period. When presented with prior payees, the user may select a photo or name, such as by tapping the photo, to select that payee. In other embodiments, the user may be presented with recent or prior payers (whom the user has received payment from).

In another embodiment, the user may be presented with photos of all people in the user's contact list, all prior payees, or another set or subset of photos. In this case, once the user selects a photo or name, the payee information is transmitted to and received by the payment provider at step 108. In one embodiment, payee information includes information that identifies the payee sufficiently to allow the payment provider to process a payment to the payee, e.g., determine an account of the payee with the payment provider. For example, payee information may include a name, a mobile phone number, a home phone number, an email address, and/or a home address of the payee.

In one embodiment, the payment provider can make a determination, at step 110, whether the selected payee is a prior payee or a prior payee within a certain time period. For example, even though the selected payee is a prior payee, the user may not have sent a payment to that payee in over five years. As such, the selected payee may not qualify as a “prior payee” by the payment provider. In other words, the selected payee may be treated the same as a new payee.

If that is the case, the payment provider may request, at step 112, additional information about the payee. This can be conventional information, such as an email address or mobile phone number of the payee, which may be entered through a keypad, voice, or other means. As a result, the payment provider can ensure that recent information about the payee is used, as opposed to an old phone number or email that would no longer identify a current account of the payee. Note that steps 110 and 112 may be omitted if the user was presented with only recent payees, e.g., payees who have received money from the user within the last six months, to select from.

After the payment provider has obtained sufficient information about the payee to identify the payee for payment, either from the information provided at step 112 or through a photo selection of a prior approved payee, the payment provider, at step 114, receives an amount of payment by the user to the payee. The amount may be entered into the user device by the user, such as through a keypad, voice, or dropdown menu with previously or commonly used amounts. The amounts from the dropdown menu may be specific to the selected payee or for ones used by the user for all payees.

The user may then be asked to confirm the payment to the selected payee. For example, the user may see a display indicating the payee (by photo and/or name) and the payment amount, along with a button or link to confirm or cancel. If the information is correct and the user wishes to make the P2P payment, the user selects the confirm button and the confirmation is communicated to and received by the payment provider at step 116.

The payment provider process the payment at step 118. Processing may include determining whether the payment can be approved, such as by determining whether the user has sufficient funds or credit to make the payment, whether there are any restrictions on the user's account precluding the payment to be made, and/or any other fraud prevention/detection checks that may be triggered or invoked. For example, the user may have reached a limit on funds sent during a current time period (month, year, etc.) or to the current payee.

If the payment is approved, the payment processor may debit a corresponding amount from the user's account and credit the payment amount to the payee's account, which can be with the payment provider. If the payee does not have an account with the payment provider, the payment provide may contact the payee (such as through the phone number or email address provided by the user), informing the payee that there is money waiting for them and to open an account to retrieve the money.

Note that one more of the steps described herein may be combined, deleted, and/or performed in a different sequence as desired.

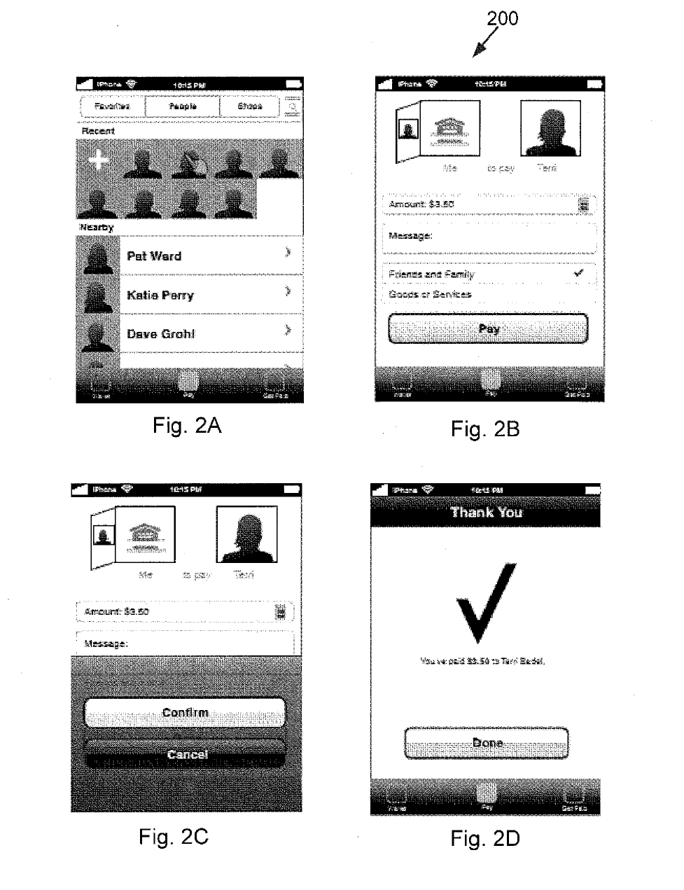

FIGS. 2A-2D are exemplary screen shots a user may see for making a person to person photo payment according to one embodiment. In FIG. 2A, the user has selected a “Pay” option in the user's account with the payment provider. Other options include “Get Paid,” which allows a user to request money, and “Wallet,” which provides access to the user's digital wallet with the payment provider. On the user device display, the user sees photos of recent payees, where “recent” can be determined by the payment provider or the user. The display also shows contacts who are near the user's current location. The contacts can be recent payees as well, any prior payee, or user contacts. The user sees the desired payee photo (second from left on top row) and selects that photo, such as by tapping on the photo.

FIG. 2B shows, along a top portion of the display, a visual display or content indicating the user intending to pay the selected payee, with a photo of the payee and possibly of the user as well. An amount field allows the user to enter a payment amount, such as through a device keypad, a message if desired, and a reason for the payment (friend or family or for a purchase). The reason may be needed so that the payment provider can determine whether a fee will be imposed for the payment transaction or for tracking purchases by the user and/or the payment provider. As seen from FIG. 2B, the user has entered $3.50 to be sent to payee Terri, who is a friend or family member. A “Pay” button can be selected by the user to communicate the payment request to the payment provider.

FIG. 2C shows payee information (photo and name) and payment amount, along with “confirm” “cancel” buttons. If the user wishes to confirm the payment, the user selects the “confirm” button, such as through a tap. The “cancel” button can be selected to cancel the current action.

FIG. 2D shows a notification sent by the payment provider that the payment has been made (with a check mark), along with payment details, such as the name of the payee and the amount. The user can select the “done” button to go back to a home page or other destination.

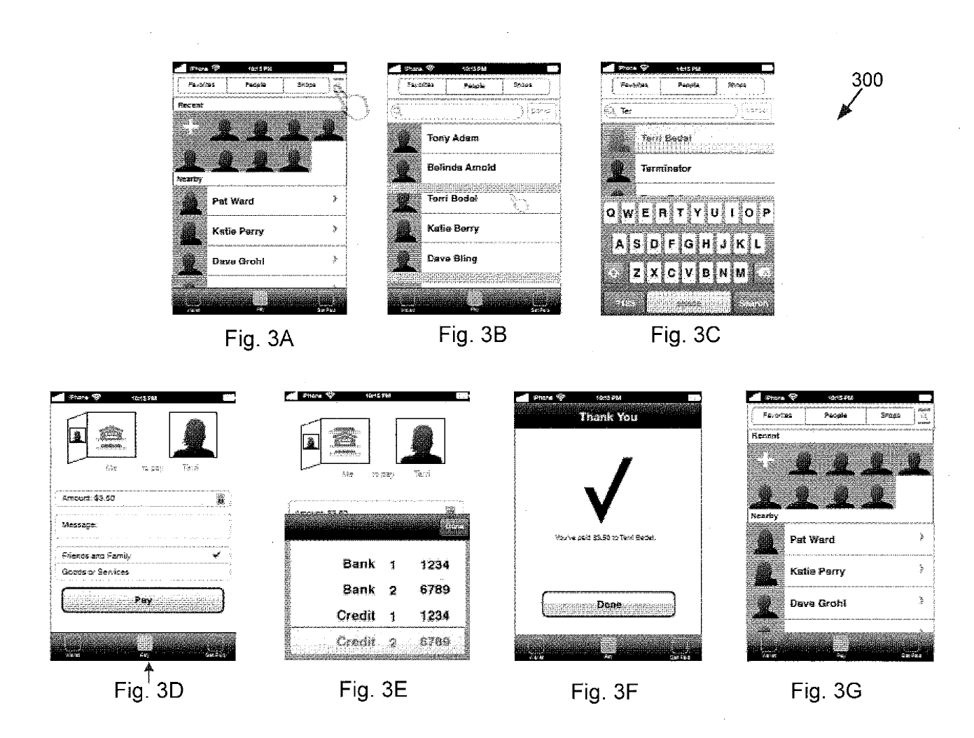

FIGS. 3A-3G are exemplary screen shots a user may see for making a person to person photo payment according to another embodiment. In FIG. 3A, the user has selected the “pay” button for a P2P payment from the user's account. The user sees a list of recent payees as well as contacts/payees nearby, as in FIG. 2A. If the user does not see the desired payee, the user may select a search button (on the upper right).

FIG. 3B shows a one way to search for a payee, where the user is presented with an alphabetical list of contacts. The user can scroll to the desired name and select that name (e.g., Terri Bedel), such as with a tap of the user's finger. FIG. 3C shows another way the user can select a payee by the user entering one or more letters of a name through a device keyboard. Results are presented on the display, and the user can select the desired payee, again through a user finger tap or other means. Note that FIG. 3A may be skipped in different embodiments, in that when the user selects a P2P service, FIG. 3B or Fib. 3C is shown to the user.

Once selected, the user sees the same page in FIG. 3D as in the previous embodiment in FIG. 2B.

FIG. 3E allows the user to change or select a funding source for the payment. A drop-down menu shows available funding sources to select from. The user may tap a desired funding source to select that funding source for the payment.

After confirming the payment, the user sees a notification screen at FIG. 3F (same as in FIG. 2D). Once the user selects the “done” button, the user may be returned to a home page or initial screen in FIG. 3G.

Thus, as seen and described, a user can quickly and easily select a payee from a photo and make a person to person payment without having to enter one or more payee identifiers, such as an email address or phone number.

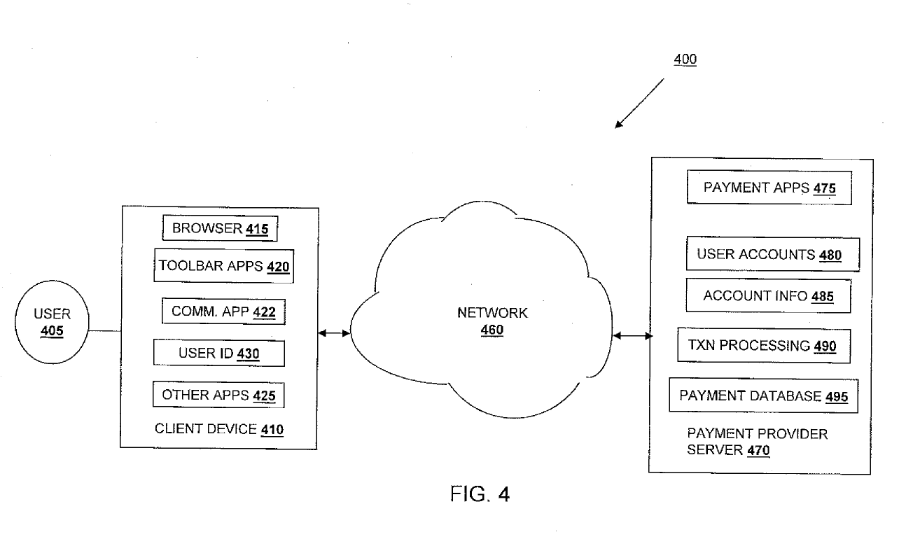

FIG. 4 is a block diagram of a networked system 400 configured to conduct a person to person photo payment, such as described above, in accordance with an embodiment of the invention. System 400 includes a user device 410 and a payment provider server 470 in communication over a network 460. Payment provider server 470 may be maintained by a payment provider, such as PayPal, Inc. of San Jose, Calif. A user 405 utilizes user device 410 to view account information and perform transaction using payment provider server 470. Note that transaction, as used herein, refers to any suitable action performed using the user device, including payments, transfer of information, display of information, etc. Although only one server is shown, a plurality of servers may be utilized. Exemplary servers may include, for example, stand-alone and enterprise-class servers operating a server OS such as a MICROSOFT® OS, a UNIX® OS, a LINUX® OS, or other suitable server-based OS. One or more servers may be operated and/or maintained by the same or different entities.

User device 410 and payment provider server 470 may each include one or more processors, memories, and other appropriate components for executing instructions such as program code and/or data stored on one or more computer readable mediums to implement the various applications, data, and steps described herein. For example, such instructions may be stored in one or more computer readable media such as memories or data storage devices internal and/or external to various components of system 400, and/or accessible over network 460.

Network 460 may be implemented as a single network or a combination of multiple networks. For example, in various embodiments, network 460 may include the Internet or one or more intranets, landline networks, wireless networks, and/or other appropriate types of networks.

User device 410 may be implemented using any appropriate hardware and software configured for wired and/or wireless communication over network 460. For example, in one embodiment, the user device may be implemented as a personal computer (PC), a smart phone, personal digital assistant (PDA), laptop computer, and/or other types of computing devices capable of transmitting and/or receiving data, such as an iPad™ from Apple™.

User device 410 may include one or more browser applications 415 which may be used, for example, to provide a convenient interface to permit user 405 to browse information available over network 460. For example, in one embodiment, browser application 415 may be implemented as a web browser configured to view information available over the Internet, such as photos of previous or recent payees from the user. User device 410 may also include one or more toolbar applications 420 which may be used, for example, to provide client-side processing for performing desired tasks in response to operations selected by user 405. In one embodiment, toolbar application 420 may display a user interface in connection with browser application 415 as further described herein.

User device 410 may further include other applications 425 as may be desired in particular embodiments to provide desired features to user device 410. For example, other applications 425 may include security applications for implementing client-side security features, programmatic client applications for interfacing with appropriate application programming interfaces (APIs) over network 460, or other types of applications. Applications 425 may also include email, texting, voice and IM applications that allow user 405 to send and receive emails, calls, and texts through network 460, as well as applications that enable the user to communicate, transfer information, and make payments through the payment provider as discussed above. User device 410 includes one or more user identifiers 430 which may be implemented, for example, as operating system registry entries, cookies associated with browser application 415, identifiers associated with hardware of user device 410, or other appropriate identifiers, such as used for payment/user/device authentication. In one embodiment, user identifier 430 may be used by a payment service provider to associate user 405 with a particular account maintained by the payment provider as further described herein. A communications application 422, with associated interfaces, enables user device 410 to communicate within system 400.

Payment provider server 470 may be maintained, for example, by an online payment service provider which may provide payment from user 405 to a designated or selected payee/recipient. In this regard, payment provider server 470 includes one or more payment applications 475 which may be configured to interact with user device 410 over network 460 to facilitate sending payments from user 405 of user device 410 to a payee as discussed above.

Payment provider server 470 also maintains a plurality of user accounts 480, each of which may include account information 485 associated with consumers, merchants, and funding sources, such as credit card companies. For example, account information 485 may include private financial information of users of devices such as account numbers, passwords, device identifiers, user names, phone numbers, credit card information, bank information, identification cards, photos, or other information which may be used to facilitate transactions by user 405.

A transaction processing application 490, which may be part of payment application 475 or separate, may be configured to receive information from a user device for processing and storage in a payment database 495. Transaction processing application 490 may include one or more applications to process information from user 405 for processing a payment using various selected funding instruments or cards. As such, transaction processing application 490 may store details of an order from individual users, including funding source(s) used, credit options available, etc. Payment application 475 may be further configured to determine the existence of and to manage accounts for user 405, as well as create new accounts if necessary, such when the user sends money to a payee who does not have a current or active account with the payment provider.

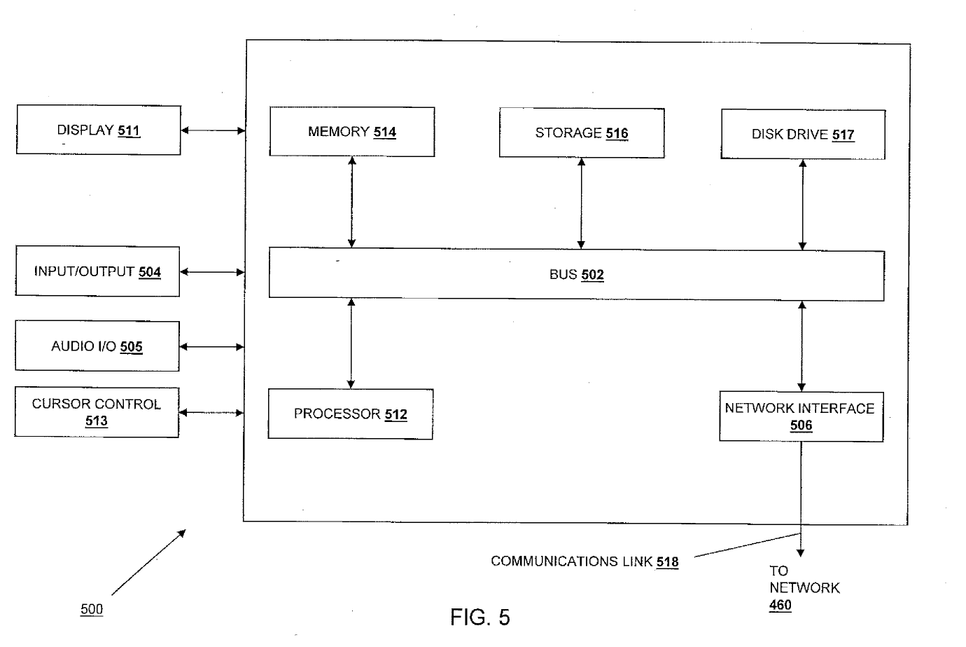

FIG. 5 is a block diagram of a computer system 500 suitable for implementing one or more embodiments of the present disclosure. In various implementations, the user device may comprise a personal computing device (e.g., smart phone, a computing tablet, a personal computer, laptop, PDA, Bluetooth device, key FOB, badge, smart watch, wearable glass, etc.) capable of communicating with the network. The payment provider may utilize a network computing device (e.g., a network server) capable of communicating with the network. It should be appreciated that each of the devices utilized by users and payment providers may be implemented as computer system 500 in a manner as follows.

Computer system 500 includes a bus 502 or other communication mechanism for communicating information data, signals, and information between various components of computer system 500. Components include an input/output (I/O) component 504 that processes a user action, such as selecting keys from a keypad/keyboard, selecting one or more buttons or links, etc., and sends a corresponding signal to bus 502. I/O component 504 may include a camera or other image capture device for capturing an image of a user card. I/O component 504 may also include an output component, such as a display 511 and a cursor control 513 (such as a keyboard, keypad, mouse, etc.). An optional audio input/output component 505 may also be included to allow a user to use voice for inputting information by converting audio signals. Audio I/O component 505 may allow the user to hear audio. A transceiver or network interface 506 transmits and receives signals between computer system 500 and other devices, such as another user device, a merchant server, or a payment provider server via network 360. In one embodiment, the transmission is wireless, although other transmission mediums and methods may also be suitable. A processor 512, which can be a micro-controller, digital signal processor (DSP), or other processing component, processes these various signals, such as for display on computer system 500 or transmission to other devices via a communication link 518. Processor 512 may also control transmission of information, such as cookies or IP addresses, to other devices.

Components of computer system 500 also include a system memory component 514 (e.g., RAM), a static storage component 516 (e.g., ROM), and/or a disk drive 517. Computer system 500 performs specific operations by processor 512 and other components by executing one or more sequences of instructions contained in system memory component 514. Logic may be encoded in a computer readable medium, which may refer to any medium that participates in providing instructions to processor 512 for execution. Such a medium may take many forms, including but not limited to, non-volatile media, volatile media, and transmission media. In various implementations, non-volatile media includes optical or magnetic disks, volatile media includes dynamic memory, such as system memory component 514, and transmission media includes coaxial cables, copper wire, and fiber optics, including wires that comprise bus 502. In one embodiment, the logic is encoded in non-transitory computer readable medium. In one example, transmission media may take the form of acoustic or light waves, such as those generated during radio wave, optical, and infrared data communications.

Some common forms of computer readable media includes, for example, floppy disk, flexible disk, hard disk, magnetic tape, any other magnetic medium, CD-ROM, any other optical medium, punch cards, paper tape, any other physical medium with patterns of holes, RAM, PROM, EEPROM, FLASH-EEPROM, any other memory chip or cartridge, or any other medium from which a computer is adapted to read.

In various embodiments of the present disclosure, execution of instruction sequences to practice the present disclosure may be performed by computer system 500. In various other embodiments of the present disclosure, a plurality of computer systems 500 coupled by communication link 518 to the network (e.g., such as a LAN, WLAN, PTSN, and/or various other wired or wireless networks, including telecommunications, mobile, and cellular phone networks) may perform instruction sequences to practice the present disclosure in coordination with one another.

Where applicable, various embodiments provided by the present disclosure may be implemented using hardware, software, or combinations of hardware and software. Also, where applicable, the various hardware components and/or software components set forth herein may be combined into composite components comprising software, hardware, and/or both without departing from the spirit of the present disclosure. Where applicable, the various hardware components and/or software components set forth herein may be separated into sub-components comprising software, hardware, or both without departing from the scope of the present disclosure. In addition, where applicable, it is contemplated that software components may be implemented as hardware components and vice-versa.

Software, in accordance with the present disclosure, such as program code and/or data, may be stored on one or more computer readable mediums. It is also contemplated that software identified herein may be implemented using one or more general purpose or specific purpose computers and/or computer systems, networked and/or otherwise. Where applicable, the ordering of various steps described herein may be changed, combined into composite steps, and/or separated into sub-steps to provide features described herein.

The foregoing disclosure is not intended to limit the present disclosure to the precise forms or particular fields of use disclosed. For example, the description is focused on person to person payments using photos of people as recipients. However, photos can also be used and selected by the user to make payments to an entity, where the photo may be of a logo, store front, or other visual image identifying a previous entity payee. As such, it is contemplated that various alternate embodiments and/or modifications to the present disclosure, whether explicitly described or implied herein, are possible in light of the disclosure. Having thus described embodiments of the present disclosure, persons of ordinary skill in the art will recognize that changes may be made in form and detail without departing from the scope of the present disclosure. Thus, the present disclosure is limited only by the claims.

What is claimed is:

1. A system comprising:
a non-transitory memory storing user account information, wherein the information comprises information identifying payees of a user from a user account; and
one or more hardware processors in communication with the non-transitory memory and configured for:
receiving a request for payment from a user to a payee;
receiving identification information of the payee from a photo selected by the user on a user device;
receiving a payment amount from the user to the payee; and
processing the request.

2. The system of claim 1, wherein the photo is selected from a plurality of photos of prior user payees.

3. The system of claim 2, wherein the plurality of photos is provided by a payment provider.

4. The system of claim 1, wherein the photo is selected from a plurality of photos of recent prior user payees.

5. The system of claim 1, wherein the one or more hardware processors is further configured for providing a list of contacts near the user.

6. The system of claim 1, wherein the one or more hardware processors is further configured for determining whether the payee is a prior payee.

7. The system of claim 1, wherein the identification information comprises an email address or a phone number.

8. The system of claim 1, wherein the one or more hardware processors is further configured for requesting the user to confirm the identification information from the photo.

9. The system of claim 8, wherein the user is requested to confirm the identification information when the payee is not a prior payee.

10. A method comprising:
receiving, electronically by a hardware processor of a payment provider, a request for payment from a user to a payee;
receiving, electronically by the hardware processor, identification information of the payee from a photo selected by the user on a user device;
receiving, electronically by the hardware processor, a payment amount from the user to the payee; and
processing the request.

11. The method of claim 10, wherein the photo is selected from a plurality of photos of prior user payees.

12. The method of claim 11, wherein the plurality of photos is provided by a payment provider.

13. The method of claim 10, wherein the photo is selected from a plurality of photos of recent prior user payees.

14. The method of claim 10, further comprising providing a list of contacts near the user.

15. The method of claim 10, further comprising determining whether the payee is a prior payee.

16. A non-transitory computer readable medium comprising a plurality of machine-readable instructions which when executed by one or more processors of a server are adapted to cause the server to perform a method comprising:
receiving a request for payment from a user to a payee;
receiving identification information of the payee from a photo selected by the user on a user device;
receiving a payment amount from the user to the payee; and
processing the request.

17. The non-transitory computer readable medium of claim 16, wherein the photo is selected from a plurality of photos of prior user payees.

18. The non-transitory computer readable medium of claim 17, wherein the plurality of photos is provided by a payment provider.

19. The non-transitory computer readable medium of claim 16, wherein the photo is selected from a plurality of photos of recent prior user payees.

20. The non-transitory computer readable medium of claim 16, wherein the method further comprises providing a list of contacts near the user.
